(19) United States
(12) Patent Application Publication
(10) Pub. No.: US 2023/0294382 A1
(43) Pub. Date: Sep. 21, 2023

(54) FUNCTIONAL LAMINATED GLASS ARTICLES AND METHODS OF MAKING THE SAME

(71) Applicant: CORNING INCORPORATED, CORNING, NY (US)

(72) Inventors: Li-Wei Chou, Hsinchu City (TW); Sean Matthew Garner, Elmira, NY (US); Jen-Chieh Lin, San Jose, CA (US); Pei-Lien Tseng, Zhubei City (TW)

(21) Appl. No.: 18/011,256

(22) PCT Filed: Jun. 25, 2021
(86) PCT No.: PCT/US2021/039081

§ 371 Date: Dec. 19, 2022

Related U.S. Application Data
(60) Provisional application No. 63/046,853, filed on Jul. 1, 2020.

(51) Int. Cl. B32B 17/06; B32B 7/12; B32B 7/02; B32B 37/12

(52) U.S. Cl. CPC B32B 17/06; B32B 7/12; B32B 7/02; B32B 37/1284; B32B 2307/7376; B32B 2255/205; B32B 2255/26; B32B 2255/28; B32B 2315/08; B32B 2457/00

(57) ABSTRACT

A functional laminated glass article includes: a backer substrate; a flexible glass substrate comprising a thickness of no greater than 300 μm, and laminated to the backer substrate with an adhesive; a plurality of conductive traces disposed on one or both of the backer substrate and the flexible glass substrate; and a plurality of electronic device elements disposed between the backer substrate and the flexible glass substrate and in contact with the plurality of conductive traces. Further, the adhesive encapsulates the conductive traces and the electronic device elements between the backer substrate and the flexible glass substrate.

### CROSS-REFERENCE TO RELATED APPLICATIONS

This application claims the benefit of priority under 35 U.S.C. § 371 of International Application No. PCT/US2021/039081, filed on Jun. 25, 2021, which claims the benefit of priority under 35 U.S.C. § 119 of U.S. Provisional Application No. 63/046,853 filed Jul. 1, 2020, the content of each of which is incorporated herein by reference in its entirety.

### FIELD

The present disclosure relates to functional laminated glass articles and methods of making the same, including methods of forming such glass articles that include a step of forming electronic devices in situ on one or more of the backer substrate and flexible glass substrate of such articles.

### BACKGROUND

Laminated glass structures may be used as components in the fabrication of various appliances, automobile components, architectural structures, and electronic devices, to name a few. For example, laminated glass structures may be incorporated as cover glass for various end products such as refrigerators, backsplashes, decorative glazing or televisions. Laminated glass structures can also be employed in laminated stacks for various architectural applications, decorative wall panels, panels designed for ease-of-cleaning and other laminate applications in which a thin glass surface is valued.

With particular regard to electronic device applications, laminated glass structures and articles can afford or otherwise enable various potential functionalities. Conventional approaches for making such functional laminated glass structures have proposed integrated discrete electronic devices (e.g., pre-existing flexible electronic devices) within the laminate. The functional laminated glass structures made by such processes, however, could be limited in terms of the size and capability of the pre-existing electronic components and devices. Moreover, differences between these electronic components and devices, e.g., the size of two or more types of electronic devices employed in the laminated structure, could add complexity, cost and reduce yield associated with subsequent lamination steps.

Accordingly, there is a need for functional laminated glass articles, and methods of making them, that offer one or more improvements, e.g., reductions in the processing and/or material cost, improvements in the performance, flexibility in the functions of such articles, and flexibility in the manufacturing of such articles.

### SUMMARY

According to an aspect of the disclosure, a functional laminated glass article is provided that includes: a backer substrate; a flexible glass substrate comprising a thickness of no greater than 300 μm, wherein the glass substrate is laminated to the backer substrate with an adhesive; a plurality of conductive traces disposed on one or both of the backer substrate and the flexible glass substrate; and a plurality of electronic device elements disposed between the backer substrate and the flexible glass substrate and in contact with the plurality of conductive traces. Further, the adhesive encapsulates the plurality of conductive traces and the plurality of electronic device elements between the backer substrate and the flexible glass substrate.

According to an aspect of the disclosure, a method of making a functional laminated glass article is provided that includes: forming a plurality of conductive traces on one or both of a backer substrate and a flexible glass substrate; mounting a plurality of electronic device elements in contact with the plurality of conductive traces and between the backer substrate and the flexible glass substrate; encapsulating the plurality of conductive traces and the plurality of electronic device elements with an adhesive; and laminating the backer substrate and the flexible glass substrate with the adhesive. Further, the flexible glass substrate has a thickness of no greater than 300 μm.

According to an aspect of the disclosure, a method of making a functional laminated glass article is provided that includes: forming a plurality of electronic devices in situ on one or both of a backer substrate and a flexible glass substrate; encapsulating the plurality of electronic devices with an adhesive; and laminating the backer substrate and the flexible glass substrate with the adhesive. Further, the flexible glass substrate has a thickness of no greater than 300 μm.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 is a cross-sectional, schematic view of a functional laminated glass article, according to an embodiment of the disclosure;

FIG. 1A is a cross-sectional, schematic view of a functional laminated glass article, according to an embodiment of the disclosure;

FIG. 2 is a flow chart schematic of a method of making a functional laminated glass article, according to an embodiment of the disclosure;

FIG. 2A is a flow chart schematic of a method of making a functional laminated glass article, according to an embodiment of the disclosure;

FIG. 3A is a schematic of a step of forming conductive traces as part of the methods of making functional laminated glass articles depicted in FIGS. 2 and 2A;

FIG. 3B is a photo of various elements employed to conduct a gravure offset printing process to form conductive traces, as part of the methods of making functional laminated glass articles depicted in FIGS. 2 and 2A;

FIG. 3C provides surface profiles of Ag- and Cu-containing conductive traces formed according to the methods of making functional laminated glass articles depicted in FIGS. 2 and 2A;

FIG. 4 is a collection of photographs of conductive traces on a flexible glass substrate, according to embodiments of the disclosure;

FIG. 5A is a schematic of steps of mounting electronic device elements as part of the methods of making functional laminated glass articles depicted in FIGS. 2 and 2A;

FIGS. 5B and 5C are photographs of electronic device elements and electronic devices on a glass backer substrate, according to embodiments of the disclosure;

FIGS. 6A-6C are schematics of encapsulating and laminating steps of the methods of making functional laminated glass articles depicted in FIGS. 2 and 2A; and

FIGS. 7A-7D are cross-sectional, schematic and exploded views of functional laminated glass articles, according to embodiments of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein-for example, “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “in situ” refers to the direct formation of a feature, e.g., an electronic device (and/or component(s) thereof), within, or on, a substrate of the laminated glass article, as part of a method of making such an article according to the principles of this disclosure.

Disclosed herein are functional laminated glass articles and methods of making them. These functional laminated glass articles possess one or more electronic devices which can be fabricated in situ and give the articles one or more electronic functionalities. Further, the laminated glass articles of the disclosure, and the methods of making them, may offer reductions in the processing cost, material cost and/or increased manufacturing and process flexibility, as compared to methods of making conventional laminated articles that rely on pre-existing electronic devices. These functional laminated glass articles also can be configured with various electronic functionalities, as enabled by the methods of making them outlined in this disclosure. Further, the methods of the disclosure can be employed to make functional laminated glass articles with an optimized stack thickness, as the stack thickness can be controlled by the in situ formation of the electronic devices and components encapsulated within these articles.

More specifically, the functional laminated glass articles of the disclosure possess a backer substrate and a flexible glass substrate with a thickness of no greater than 300 μm. The substrates are laminated together with an adhesive. Further, conductive traces are located on one or both of the substrates, and electronic device elements are disposed in contact with these conductive traces and between the substrates. In addition, the adhesive encapsulates the conductive traces and the electronic device elements. In some implementations, the conductive traces and electronic device elements collectively form electronic devices, as encapsulated within the adhesive that laminates the substrates of the functional laminated glass article.

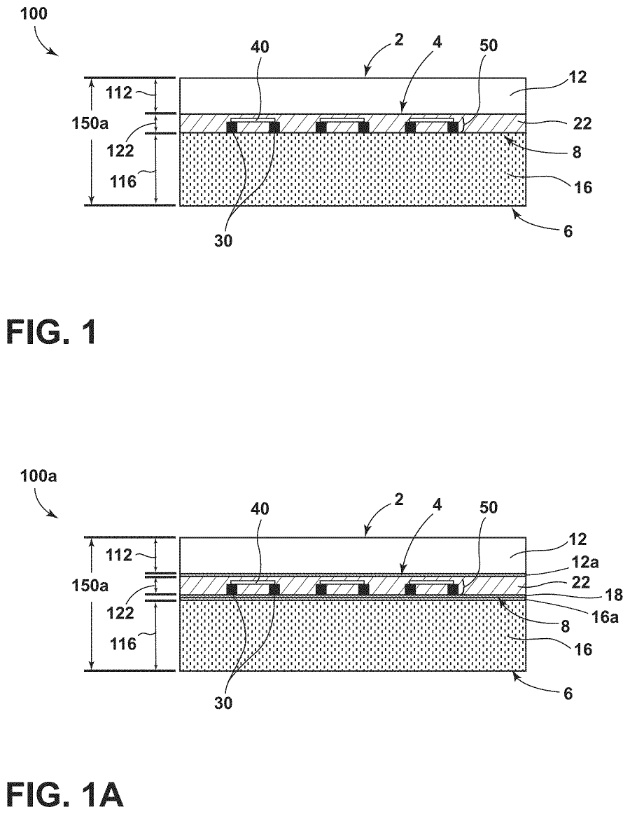

Referring now to FIG. 1, an exemplary, functional laminated glass article 100 is provided according to an embodiment of the disclosure. The laminated glass article 100 includes a backer substrate 16 having upper and lower primary surfaces 8, 6; a flexible glass substrate 12 having upper and lower primary surfaces 2, 4; and an adhesive 22. The backer substrate 16, flexible glass substrate 12 and adhesive 22 possess thicknesses 116, 112 and 122, respectively. Further, the laminated glass article 100 has a total thickness 150a. As shown in FIG. 1, the flexible glass substrate 12 is laminated to the primary surface 8 of the backer substrate 16 with the adhesive 22.

Referring again to FIG. 1, the functional laminated glass article 100 also includes one or more conductive traces 30 disposed on one or both of the backer substrate 16 and the flexible glass substrate 12. According to some embodiments, the conductive traces 30 are deposited in contact with the upper primary surface 8 of the backer substrate 16 (as shown in FIG. 1) and/or in contact with the lower primary surface 4 of the flexible glass substrate 12 (not shown). According to some embodiments of the laminated glass article 100, the conductive traces 30 are configured to exhibit a relatively low electrical resistivity, e.g., from 0.01 Ω·cm to 2 Ω·cm, from 0.05 Ω·cm to 1.5 Ω·cm, from 0.1 Ω·cm to 1 Ω·cm, from 0.2 Ω·cm to 0.8 Ω·cm, and all electrical resistivity values between the foregoing ranges. In some implementations, the conductive traces are configured from an electrically conductive material. In some implementations, the conductive traces 30 contain one or more of the following metals or alloys: Cu, Ag, Pt, Al, and alloys of these metals. Further, according to some embodiments, the conductive traces 30 include one or more layers of the following metals or alloys: Cu, Ag, Pt, Al, and alloys of these metals. In addition, according to some embodiments, the conductive traces 30 can include one or more transparent conductors such as indium tin oxide (ITO), indium zinc oxide (IZO), aluminum-doped zinc oxide (AZO), and graphene.

As also depicted in FIG. 1, the functional laminated glass article 100 includes one or more electronic device elements 40 disposed between the backer substrate 16 and the flexible glass substrate 12. In addition, the electronic device elements 40 are disposed in contact with one or more of the conductive traces 30. The electronic device elements 40 can be placed directly in contact with the conductive traces 30, or in electrical contact with the conductive traces 30 through a conductive intermediate material (e.g., a solder, conductive epoxy, flux, etc.). In some embodiments, the collection of conductive traces 30 and electronic device elements 40 define one or more electronic devices 50. In some implementations of the laminated glass article 100, the electronic devices 50 and/or the collection of conductive traces 30 and electronic device elements 40 enable the article 100 to function as one or more of a sensor, an actuating switch (on/off), a heartbeat sensor, a touch sensor, a light-emitting diode (LED) display, an organic light-emitting (OLED) display, OLED lighting, a radio frequency identification (RFID) antenna or other antenna, a motion sensor, a photovoltaic device, and an electromagnetic shielding and filtering device. The functional laminated glass article 100 can also be configured with conductive traces 30, electronic device elements 40 and/or electronic devices 50 to perform other functions associated with various electronic devices and assemblies, as would be understood by those of ordinary skill in the field of this disclosure, e.g., pressure sensing, temperature sensing, lighting, displays, photovoltaic and other functions.

Referring to FIG. 1, the functional laminated glass article 100 further includes an adhesive 22 that encapsulates the conductive trace(s) 30 and the electronic device element(s) 40, as situated between the flexible glass substrate 12 and the backer substrate 16. As such, embodiments of the functional laminated glass article 100 include an adhesive 22 with a suitable viscosity range and/or process capability to ensure that conductive trace(s) 30 and the electronic device element(s) 40 are encapsulated between the flexible glass substrate 12 and the backer substrate 16 while minimizing the thickness 150a of the laminated article 100. In some embodiments, the adhesive 22 can be an optically clear adhesive (OCA), an ethylene vinyl acetate (EVA) adhesive, a silicone adhesive, a pressure sensitive adhesive film, a thermoplastic adhesive, or ultraviolet (UV)-curable resin adhesive. In some embodiments of the laminated article 100 in which the article has an optical functionality (e.g., as a display device), the adhesive 22 employed in the article 100 should have high optical transmissibility in the visible spectrum, e.g., an OCA. The adhesive 22 may also assist in attaching the flexible glass substrate 12 to the backer substrate 16 during and/or prior to a lamination process step. Some examples of low temperature adhesive materials include Norland Optical Adhesive 68 (Norland Products, Inc.) cured by ultra-violet (UV) light, FLEXcon V29TT adhesive, 3M™ optically clear adhesive 8211, 8212, 8214, 8215, 8146, 8171, and 8172 (bonded by pressure at room temperature or above), 3M™ 4905 tape, OptiClear® adhesive, silicones, acrylates, optically clear adhesives, encapsulant material, polyurethane polyvinylbutyrates, ethylenevinylacetates, ionomers, and wood glues. To the extent that the functional laminated glass article 100 is to be used in higher temperature environments in excess of about 50° C., suitable higher temperature adhesive materials for the adhesive 22 include DuPont SentryGlas®, DuPont PV 5411, Japan World Corporation material FAS and polyvinyl butyral resin.

In certain implementations of the functional laminated glass article 100 depicted in FIG. 1, the backer substrate 16 has a thickness 116 from about 0.1 mm to about 100 mm, from about 0.1 mm to about 75 mm, from about 0.5 mm to about 50 mm, or from about 1 mm to about 25 mm, and all thickness values between the foregoing ranges. In some embodiments, the laminated glass article 100 is configured such that the primary surfaces 6, 8 of the backer substrate 16 can each be characterized with a surface area of at least 0.5 m², 1 m², or 2 m². Further, the backer substrate 16 can include one or more of the following materials: a metal alloy, a polymer (e.g., a polycarbonate), a glass, a glass-ceramic, a ceramic, a high pressure laminate (HPL), and a medium density fiberboard (MDF). The backer substrate 16 can be transparent, opaque, or scattering in portions of the visible, infrared, and radio wave spectra. The backer substrate 16 can be a multi-layer stack or composite of these materials. For example, the backer substrate 16 can be a multilayer stack of metal and MDF. The backer substrate can have surface roughness (Ra) values >1 nm, >10 nm, >50 nm, >100 nm, >500 nm, >1000 nm, or surface roughness values greater than values between the foregoing lower threshold surface roughness values. According to embodiments, metal alloys suitable for the backer substrate 16 can include, but are not limited to, stainless steel, aluminum, nickel, magnesium, brass, bronze, titanium, tungsten, copper, cast iron, ferrous steels, and noble metals. In embodiments of the functional laminated glass article 100 in which the conductive traces 30 are in contact with the backer substrate 16, any such metal alloy should include an electrically insulating film or layer between the substrate 16 and the conductive traces 30. In other embodiments of the functional laminated glass article 100 depicted in FIG. 1, the backer substrate 16 may be formed using one or more polymer materials including, but not limited to, polyethylene terephthalate (PET), polyethylene naphthalate (PEN), ethylene tetrafluoroethylene (ETFE), or thermopolymer polyolefin (TPO™—polymer/filler blends of polyethylene, polypropylene, block copolymer polypropylene (BCPP), or rubber), polyesters, polycarbonate, polyvinylbuterate, polyvinyl chloride, polyethylene and substituted polyethylenes, polyhydroxybutyrates, polyhydroxyvinylbutyrates, polyetherimides, polyamides, polyethylenenaphalate, polyimides, polyethers, polysulphones, polyvinylacetylenes, transparent thermoplastics, transparent polybutadienes, polycyanoacrylates, cellulose-based polymers, polyacrylates and polymethacrylates, polyvinylalcohol, polysulphides, polyvinyl butyral, polymethyl methacrylate and polysiloxanes.

In an implementation of the functional laminated glass article 100 shown in FIG. 1, the backer substrate 16 is of a polycarbonate or a steel alloy, as both materials can serve as a substrate conducive to the deposition of conductive materials, such as the conductive traces 30. Further, a backer substrate 16 fabricated of a metal alloy (e.g., a stainless steel) provides a particular advantage in the development of beneficial residual compressive stresses in the flexible glass substrate 12 upon cooling after lamination. These residual stresses develop due to a significant mismatch in the coefficients of thermal expansion (CTE) between the metal alloy backer substrate 16 and the flexible glass substrate, e.g., the CTE of a metal alloy backer substrate 16 (˜13×10⁻⁶/° C.) is 3-5× greater than the CTE of the flexible glass substrate 12 (˜3.2×10⁻⁶/° C.).

Referring to FIG. 1 again, the flexible glass substrate 12 of the functional laminated glass article 100 has a thickness 112 of no greater than 300 μm. In some implementations of the article 100, the thickness 112 of the flexible glass substrate 12 is from 10 μm to 300 μm, 25 μm to 250 μm, from 50 μm to 200 μm, and all thickness values between the foregoing ranges. For example, the thickness 112 of the flexible glass substrate 12 can be 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, and all thickness values between these thicknesses.

As also depicted in FIG. 1, the backer substrate 16 has a thickness 116 within the functional laminated glass article 100. In certain embodiments, the thickness 116 ranges from about 0.1 mm to about 100 mm and, preferably, from about 0.5 mm to about 50 mm. In certain other aspects, the thickness 116 of the backer substrate 16 ranges from about 0.5 mm to about 50 mm. For example, the thickness 116 can be about 0.5 mm, 1.0 mm, 1.5 mm, 2.0 mm, 2.5 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 35 mm, 40 mm, 45 mm, 50 mm, and all thickness values between these thicknesses. The backer substrate 16 can be thicker than the flexible glass substrate 12. For example, the ratio of backer substrate 16 to the flexible glass substrate thicknesses can be ≥1.5:1, ≥2:1, ≥3:1, ≥5:1, ≥10:1, ≥20:1, ≥50:1, ≥100:1.

Referring again to FIG. 1, the flexible glass substrate 12 may be formed of glass, a glass ceramic, a ceramic material or composites thereof. A fusion process (e.g., a down-draw process) that forms high quality flexible glass sheets can be used in a variety of devices, and one such application is flat panel displays. Glass sheets produced in a fusion process have surfaces with superior flatness and smoothness when compared to glass sheets produced by other methods. The fusion process is described in U.S. Pat. Nos. 3,338,696 and 3,682,609, the disclosures of which are hereby incorporated by reference. Other suitable glass sheet forming methods include a float process, up-draw and slot draw methods. Further, a suitable glass for the flexible glass substrate 12 of the functional laminated glass article 100 shown in FIG. 1 is Corning® Willow® Glass, as sized with a thickness 112 of no greater than 300 μm.

Again as shown in FIG. 1, the adhesive 22 of the functional laminated glass article 100 may be thin, having thicknesses 122 of less than or equal to about 500 μm, about 250 μm, less than or equal to about 50 μm, less than or equal to 40 μm, or less than or equal to 20 μm. Further, the thickness 122 of the adhesive 22 is greater than about 25 μm, according to embodiments. In other aspects, the thickness 122 of the adhesive 22 is from about 0.025 mm to about 0.5 mm. The adhesive 22 may also contain other functional components such as color, decoration, heat or UV resistance, AR filtration, etc. The adhesive 22 may be optically clear on cure, or it may otherwise be opaque. For those embodiments in which the adhesive 22 comprises a sheet or film of adhesive, the adhesive 22 may have a decorative pattern or design that is visible through the thickness 112 of the flexible glass substrate 12. Similarly, to the extent that the backer substrate 16 has clarity, the adhesive 22 may also have a decorative pattern or design that is visible through the thickness 116 of the backer substrate 16.

As also depicted in FIG. 1, the adhesive 22 of the functional laminated glass article 100 can be formed of a liquid, gel, sheet, film or a combination of these forms. Further, in some aspects, the adhesive 22 can exhibit a pattern of stripes that are visible from an outer surface of the flexible glass substrate 12 and/or backer substrate 16, provided that it has sufficient optical clarity. In some embodiments, the backer substrate 16 and/or the flexible glass substrate 12 may include a decorative pattern. In some embodiments, the decorative pattern may be provided within multiple layers, e.g., within the flexible glass substrate 12, backer substrate 16 and/or adhesive 22.

Referring again to FIG. 1, the overall thickness 150a of the functional laminated glass article 100 can range from about 0.1 mm to about 100 mm, preferably from about 0.5 mm to about 50 mm. In particular, the overall thickness of the laminated glass article 100 is given by the sum of the thicknesses 112, 116 and 122 of the flexible glass substrate 12, backer substrate 16, and adhesive 22, respectively. Accordingly, the overall thickness of the laminated glass article 100 can be about 0.1 mm, 0.5 mm, 1 mm, 1.5 mm, 2.0 mm, 2.5 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 40 mm, 45 mm, 50 mm, 55 mm, 60 mm, 70 mm, 80 mm, 90 mm, 100 mm, and all thickness values between these overall thicknesses.

Referring now to FIG. 1A, an exemplary, functional laminated glass article 100a is provided according to an embodiment of the disclosure. The laminated glass article 100a is substantially similar to the functional laminated glass article 100 depicted in FIG. 1. Accordingly, like-numbered elements of the articles 100 and 100a have the same or substantially similar structures and functions, unless otherwise noted. In addition, the functional laminated article 100a depicted in FIG. 1A, further includes one or more decoration layers 12a, 16a. As depicted in the figure, the decoration layers 12a and 16a are disposed on the lower primary surface 4 of the flexible glass substrate 12 and the upper primary surface 8 of the backer substrate 16. In implementations of the laminated article 100a in which one or more of the flexible glass substrate 12 and backer substrate 16 are substantially transparent, one or more of these decoration layers 12a, 16a are visible and can provide a decorative aesthetic for the article 100a. According to embodiments, the decorative layers 12a, 16a can comprise any of the same materials as the flexible glass substrate 12 and/or the backer substrate 16 in contact with these layers. In addition, the decorative layers 12a, 16a can comprise any other materials, e.g., paper, polymeric materials, cardboard, etc., with pigments, inks, and/or colored aspects.

In addition, as also depicted in FIG. 1A, the functional laminated glass article 100a may include one or more isolation layers 18 located between the conductive traces 30 and the backer substrate 16. In embodiments of the laminated article 100a in which the backer substrate 16 includes electrically conductive materials, such as a steel alloy, the isolation layer 18 ensures that the conductive traces 30 are electrically isolated from the backer substrate 16. As such, the isolation layer(s) include one or more electrically insulating materials, e.g., an inorganic oxide coating or layer (e.g., Al₂O₃), a non-conductive glass, ceramic or glass-ceramic material, an insulating polymer, such as PET, etc.

With regard to processing of the functional laminated glass articles 100 and 100a (see FIGS. 1 and 1A) consistent with the principles of the disclosure, those with ordinary skill in the art can readily appreciate that various lamination methods can be employed to fabricate these structures. For example, high pressure and low pressure lamination approaches can be employed that are comparable to those typically used with conventional laminates, depending on the composition of the backer substrate 16 and other elements of the laminated glass articles 100 and 100a. In certain embodiments of the methods employed to fabricate the laminated glass articles 100 and 100a, various surface treatments (e.g., plasma cleaning, etching, polishing and others) can be applied to the primary surface 8 of the backer substrate 16 to facilitate improved lamination with the flexible glass substrate 12 by the adhesive 22 and/or improved adhesion of the conductive traces 30.

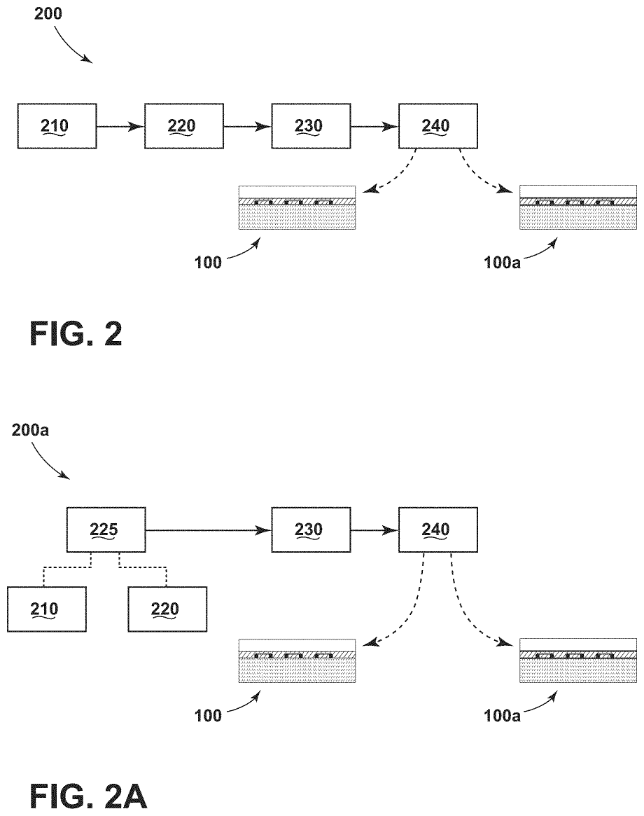

Referring now to FIG. 2, a method 200 of making a functional laminated glass article 100, 100a (see also FIGS. 1, 1A) is depicted in schematic form. The method 200 includes: a step 210 of forming one or more conductive traces 30 on one or both of a backer substrate 16 and a flexible glass substrate 12 (i.e., as having a thickness 112 of no greater than 300 μm); and a step 220 of mounting one or more electronic device elements 40 in contact with the conductive trace(s) 30 and between the backer substrate 16 and the flexible glass substrate 12. The method 200 further includes: a step 230 of encapsulating the conductive trace(s) 30 and the electronic device element(s) 40 with an adhesive 22; and a step 240 of laminating the backer substrate 16 and the flexible glass substrate 12 with the adhesive 22.

Referring to FIG. 2A, a method 200a of making a functional laminated glass article 100, 100a (see also FIGS. 1, 1A) is depicted in schematic form. The method 200a of making a laminated glass article 100, 100a is substantially similar to the method 200 of making a functional laminated glass article 100, 100a depicted in FIG. 2. Accordingly, like-numbered elements of the methods 200 and 200a have the same or substantially similar steps, sequences and functions, unless otherwise noted. In addition, the method 200a also includes a step 225 of forming one or more electronic devices 50 in situ on one or both of the backer substrate 16 and a flexible glass substrate 12. Further the step 230 is conducted to encapsulate the electronic devices 50 with the adhesive 22. As is also evident from FIG. 2A, embodiments of method 200a can be conducted such that the step 225 of forming one or more electronic devices 50 can include sub-steps 210 and 220 of forming and mounting one or more conductive traces 30 and one or more electronic device elements 40, as described above (see FIG. 2 and corresponding description). According to some implementations of the method 200a, the step 225 of forming the electronic devices 50 in situ can include one or more of a gravure offset printing (GOP) process, an electroless deposition (ELD) process (e.g. electroless depositing), a surface mounting process, a laser-assisted selective deposition process (e.g. selective depositing), and a laser jet printing process.

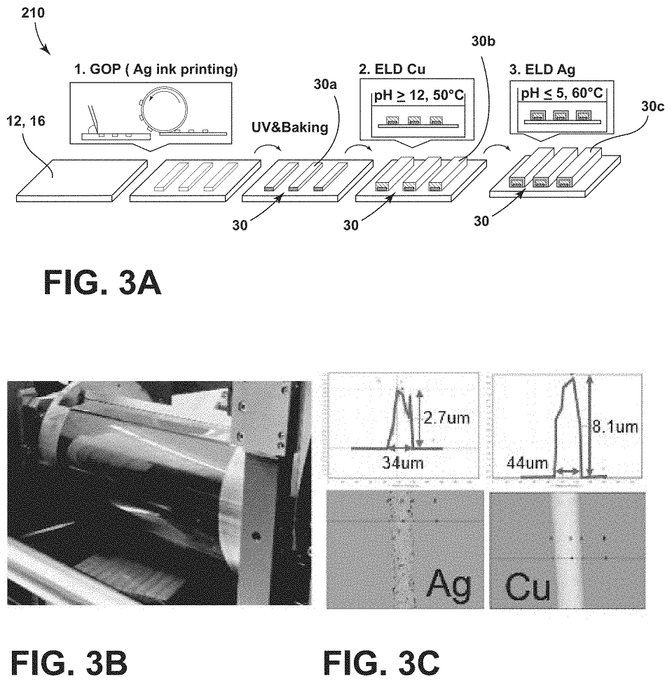

According to some embodiments of the method 200, 200a (see FIGS. 2, 2A) of making a functional laminated glass article 100, 100a, the step 210 of forming one or more conductive traces 30 can be conducted by one or more of a GOP process, an ELD process, a laser-assisted selective deposition process, and a laser jet printing process. Referring now to FIG. 3A, a schematic is provided of an implementation of step 210 of forming conductive trace(s) 30 as part of the methods 200, 200a of making functional laminated glass articles depicted in FIGS. 2 and 2A. As demonstrated by FIG. 3A, step 210 can involve a GOP process step, along with UV light curing and baking steps, to form a set of Ag-containing conductive traces 30a comprising Ag ink. As shown in FIG. 3B, a particular ink pattern can be transferred to a backer substrate 16 via a rubber-covered roller as part of a GOP process step. The Ag-containing ink, according to some embodiments, is a paste containing a polymer, a solvent, and Ag particles on a submicron and micron scale. The UV curing and baking sub-steps are aimed at removing the solvent and crosslinking the polymer for adhesion of the Ag-containing ink on the backer substrate 16. To the extent that the ink employs a thermoplastic polymer or a thermosetting polymer with a low temperature curing schedule, the UV curing step is optional and may not be necessary. As shown in FIG. 3C, exemplary conductive traces 30a containing Ag were fabricated with a process including GOP, baking and UV curing steps and exhibited a thickness of 2.7 μm and a linewidth of 34 μm.

Referring again to FIG. 3A, implementations of step 210 can further involve an ELD process step to form conductive traces 30b, which include a Cu layer over the Ag ink layer formed by a GOP process, as described above. The Ag particles in the conductive traces 30a can serve as reactive centers as a catalyst to conduct redox reactions in which Cu solute deposits selectively on the Ag particles, as shown in FIG. 3A. Further, according to some embodiments, an ELD step of depositing Cu over Ag particles to form conductive traces 30b can be conducted with a basic Cu-containing solution (i.e., pH≥12) at a temperature of about 50° C. As part of the ELD process step, the thickness of the Cu layer can be varied as a function of deposition time; preferably, the thickness of the Cu layer should be controlled to be no greater than 10 μm to avoid self-peeling from the accumulation of excess internal stress. As shown in FIG. 3C, an exemplary Cu layer of the conductive traces 30b was formed and deposited through an ELD process step with a thickness of 8.1 μm and a linewidth of 44 μm. In some embodiments, the conductive traces 30b, as containing Ag and Cu metal, employ a Cu layer having a thickness of about 2 μm to avoid self-peeling while maintaining low electrical resistivity. In addition, as also shown in FIG. 3A, an optional layer of Ag can be deployed through an ELD process over the conductive traces 30b to form conductive traces 30c which possess a Ag/Cu/Ag layer structure. In this implementation of step 210, the ELD-deposited Ag mainly exchanges Cu surface atoms (i.e., within a few hundred nm) of the conductive traces 30b to form conductive traces 30c having decorative and protective functions, particularly to reduce the potential for oxidation of the underlying Cu layer. Further, according to some embodiments, an ELD process step of depositing Ag over an Ag/Cu layer structure to form conductive traces 30c as part of a step 210 can be conducted with an acidic Ag-containing solution (i.e., pH≤5) at a temperature of about 60° C.

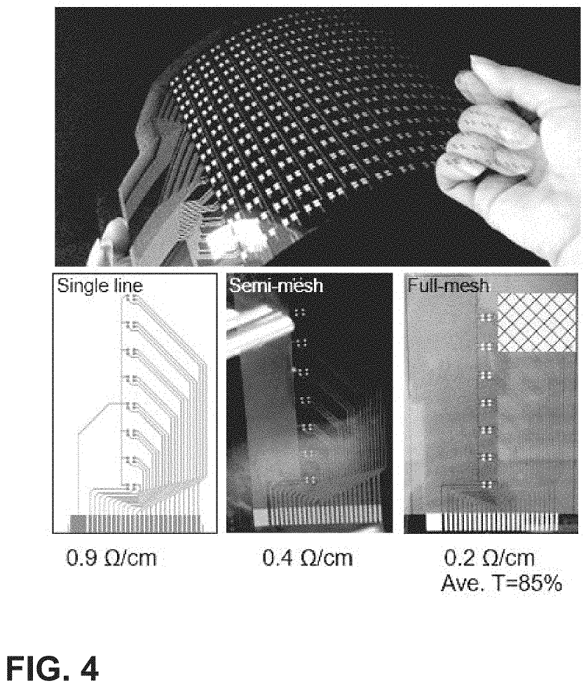

According to some implementations, the conductive trace(s) 30 formed according to the method 200, 200a can be characterized with a relatively low electrical resistivity, e.g., from 0.01 Ω·cm to 2 Ω·cm, from 0.05 Ω·cm to 1.5 Ω·cm, from 0.1 Ω·cm to 1 Ω·cm, from 0.2 Ω·cm to 0.8 Ω·cm, and all electrical resistivity values between the foregoing ranges. For example, as shown in FIG. 4, Cu-containing conductive traces can be formed, e.g., according to step 210 with GOP and ELD process sub-steps, on a flexible glass substrate 12 (˜200 mm×200 mm) with varying structures and electrical resistivity. Nevertheless, the Cu-containing conductive traces shown in FIG. 4 are also exemplary of a process for forming them on the backer substrate 16. More particularly, as shown in FIG. 4, the following exemplary conductive trace structures were formed: a single line structure having an electrical resistivity of 0.9 Ω·cm; a semi-mesh structure having an electrical resistivity of 0.4 Ω·cm; and a full-mesh structure having an electrical resistivity of 0.2 Ω·cm. In terms of appearance, the single line structure has excellent optical transmissivity; however, the lines converge with a high density creating a high degree of contrast. In contrast, the semi-mesh and full-mesh structures provide better electrical resistivity (0.4 and 0.2 Ω·cm, respectively) and relatively uniform optical transmittance of about 85% in the visible spectral region.

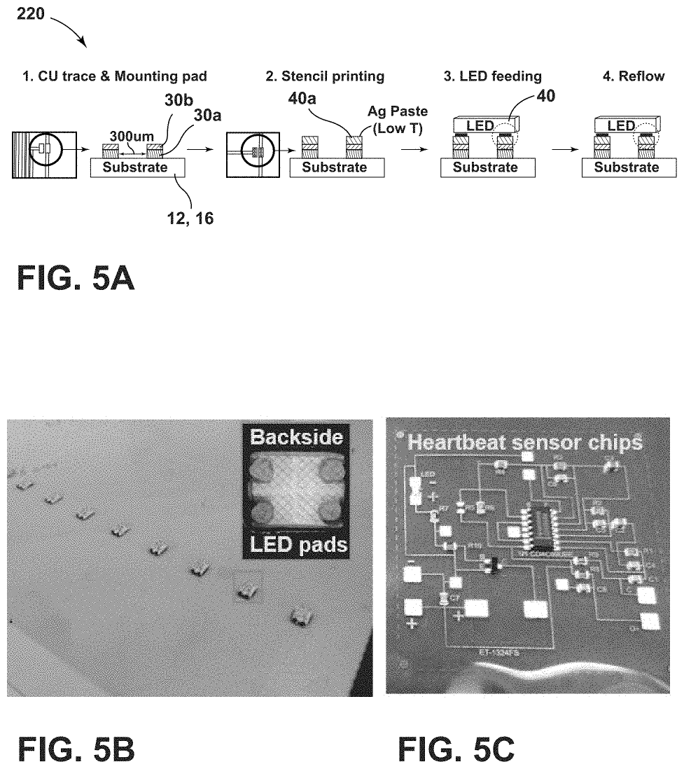

According to some implementations of the method 200, 200a (see FIGS. 2, 2A) of making a functional laminated glass article 100, 100a, the step 220 of mounting one or more electronic device elements 40 can be conducted with a surface mounting technology (SMT) process such that each electronic device element 40 is in electrical contact with one or more conductive traces 30 with a conductive epoxy paste, e.g., as shown in FIG. 5A (i.e., “Ag Paste”). More particularly, FIG. 5A is a schematic of an exemplary implementation of a step 220 of mounting electronic device elements 40 as part of the methods 200, 200a of making functional laminated glass articles 100, 100a (see FIGS. 1-2A). As is evident from FIG. 5A, step 220 can be conducted with a conventional SMT process to bond or otherwise place electronic device elements 40 in contact with one or more underlying conductive traces, e.g., conductive traces 30a, 30b. As shown, the conductive traces 30a, 30b are formed using suitable processes, e.g., GOP and ELD, as described earlier (see FIGS. 3A-3C and corresponding description). To physically secure the electronic device elements 40 (e.g., LED chips), Ag or Sn solder paste can be applied by stencil printing and/or a dispenser locally on each conductive trace in a manner that avoids causing unintended solder bridges between neighboring conductive traces. Next, the electronic device elements 40 are fed onto the Ag or Sn solder paste, to place them in electrical contact with one or more of the conductive traces 30a, 30b. At this point, the Ag or Sn solder paste holding the electronic device elements 40 in contact with one or more of the conductive traces 30a, 30b is subjected to a thermal reflow process step (e.g., about 120° C. for Ag solder paste and about 220° C. for Sn solder paste).

As shown in FIGS. 5B and 5C, exemplary electronic device elements and electronic devices are depicted, as made on a glass backer substrate (e.g., backer substrate 16) according to the step 220 of the methods 200, 200a (see FIGS. 2, 2A and 5A and corresponding description). Note that the electronic device elements and devices shown in FIGS. 5B and 5C are exemplary in the sense that they could likewise be developed on a flexible glass substrate (e.g., flexible glass substrate 12) according to the principles of this disclosure. More particularly, FIG. 5B shows a set of LED chips mounted on a backer substrate with an SMT process according to step 220. FIG. 5B also includes an enlarged view of the backside of one of the RGB LED chips that shows four conductive traces (e.g., solder bumps). Similarly, as shown in exemplary form in FIG. 5C, heartbeat sensor chips can be mounted on a backer substrate with an SMT process according to step 220.

According to some embodiments of the method 200, 200a (see FIGS. 2, 2A) of making a functional laminated glass article 100, 100a, the step 230 of encapsulating the conductive traces 30 and the electronic device elements 40 can be conducted by one of a nip-roller process, a stamping process and a dam-to-fill process. In addition, and as noted earlier, the adhesive 22 employed in step 230 can be one or more of an OCA, an EVA, and a silicone adhesive.

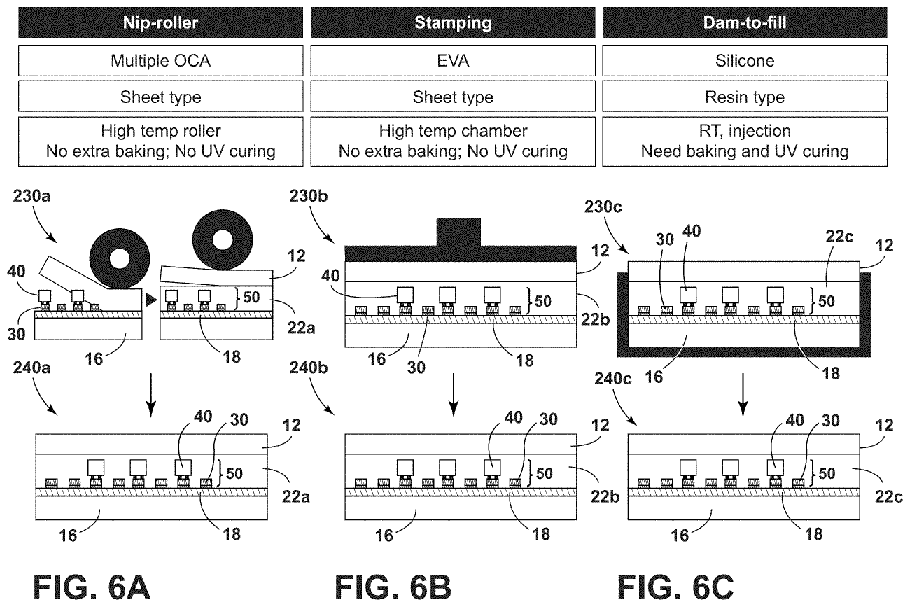

Referring now to FIGS. 6A and 6B, schematics are provided of steps 230a, 230b of encapsulating the conductive traces 30 and electronic device elements 40 (and/or the electronic devices 50), and steps 240a, 240b of laminating the backer substrate 16 and the flexible glass substrate 12 with the adhesive 22a, 22b. As shown in FIG. 6A, step 230a can be conducted with a nip-roller process to press the adhesive 22a (e.g., an OCA in sheet form) over the conductive traces 30 and electronic device elements 40, thus encapsulating these features in a manner to control and, in some cases, minimize the overall thickness of the article. Further, step 240a can be conducted with a nip-roller process to laminate the backer substrate 16 to the flexible glass substrate 12 with the adhesive 22a. An advantage of the implementation depicted in FIG. 6A is that the nip-roller approach can be employed to use multiple layers of adhesive 22a, providing more flexibility in the development and encapsulation of complex electronic architectures (e.g., conductive traces 30, electronic device elements 40 and electronic devices 50). Similarly, as shown in FIG. 6B, step 230b can be conducted with a stamping process to encapsulate the conductive traces 30 and electronic device elements 40 with an adhesive 22b (e.g., an EVA adhesive in sheet form). Further, step 240b can be conducted with a stamping process to laminate the backer substrate 16 to the flexible glass substrate 12 with the adhesive 22b. In embodiments of the steps 230a, 230b, 240a and 240b depicted in FIGS. 6A and 6B, the respective nip-roller and stamping processes are conducted with a pressing force at elevated temperatures, e.g., from about 100° C. to 120° C., such that the respective adhesives 22a and 22b become relatively fluid to improve the encapsulating and laminating aspects of these approaches.

With regard to FIG. 6C, step 230c can be conducted with a dam-to-fill process to fill an adhesive 22c (e.g., a silicone adhesive in liquid, resin form) over the conductive traces 30 and electronic device elements 40, thus encapsulating these features. Typically, step 230c requires additional baking (at least 150° C.) and UV curing steps to set the silicone adhesive 22c over the backer substrate 16. Further, step 240c can be conducted with a stamping process to laminate the backer substrate 16 to the flexible glass substrate 12 with the adhesive 22c.

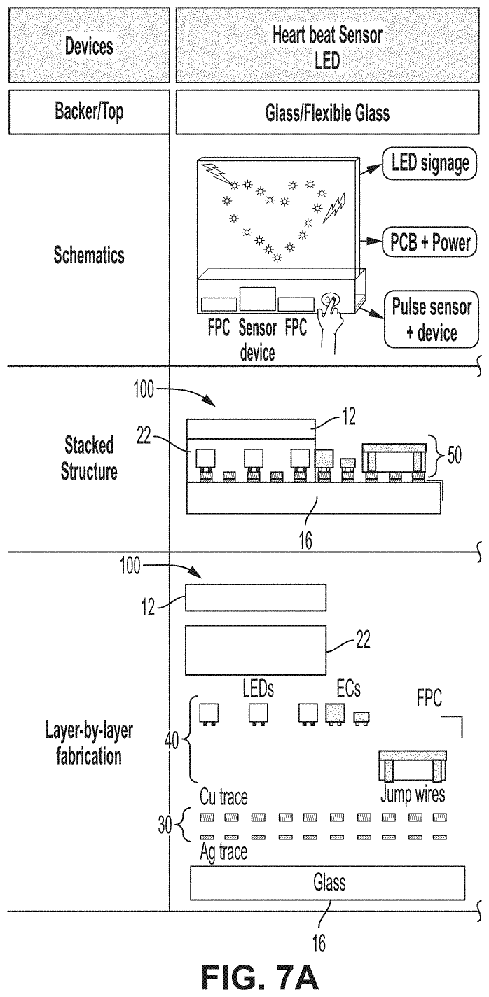

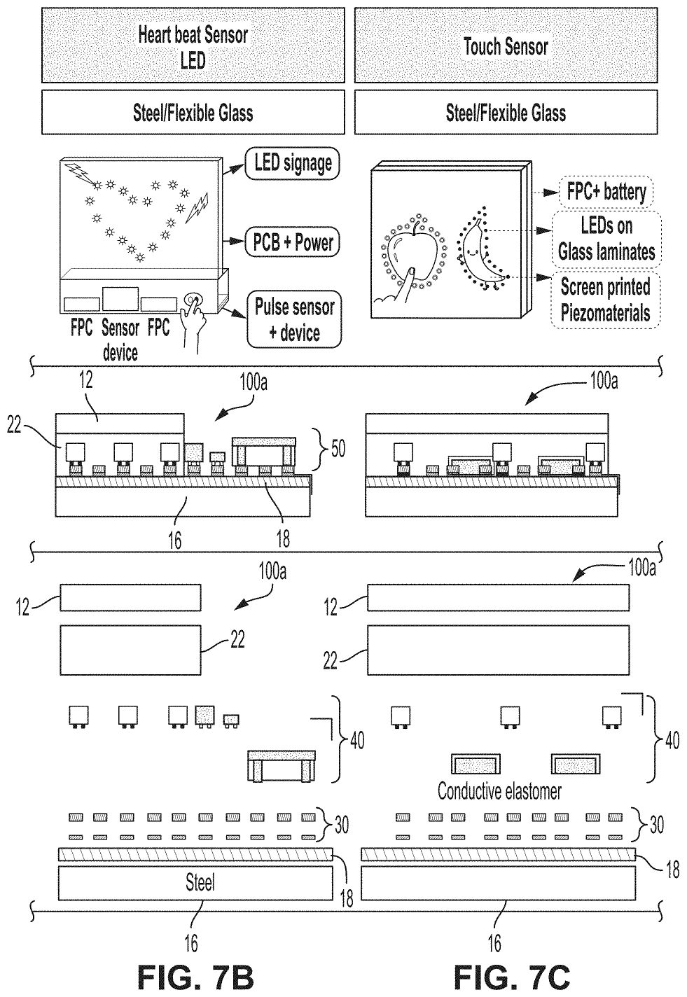

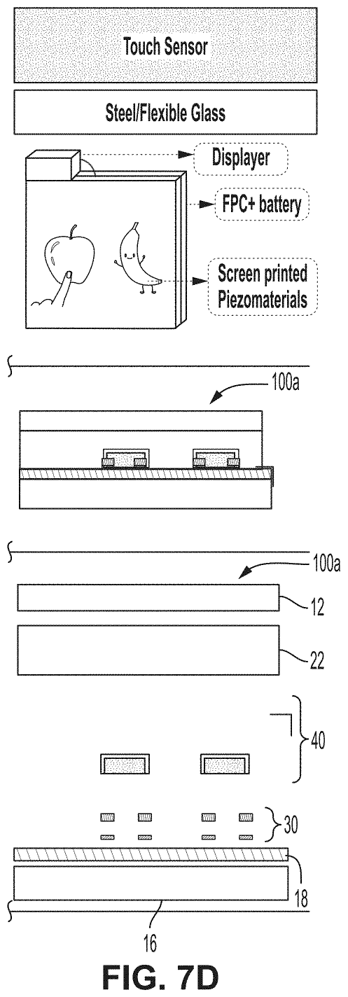

Referring now to FIGS. 7A and 7B, cross-sectional, schematic and exploded views are provided of two exemplary functional laminated glass articles 100, 100a (see FIGS. 1, 1A and corresponding description). Each of the devices shown in FIGS. 7A and 7B is a heartbeat sensor equipped with 48 LEDs soldered on printed Cu conductive traces with a flexible glass substrate 12 and a backer substrate 16. The heartbeat sensor shown in FIG. 7A employs a backer substrate 16 with a glass composition. In contrast, the heartbeat sensor shown in FIG. 7B employs a backer substrate 16 fabricated from a steel alloy, along with an isolation layer 18. The dual-function circuits of these devices (i.e., conductive traces 30) can be directly printed with Ag ink using a GOP process, followed by high temperature baking and UV curing process steps. Further, an ELD process can be employed to selectively deposit Cu layers on the Ag traces with thicknesses of about 1 to 2 μm, or about 1 to 10 μm and linewidths of 10 μm or more. LEDs and other electronic components (ECs) (i.e., electronic device elements 40) can be automatically fed and placed on the Ag/Cu conductive traces with a pre-coated solder paste. A flexible printed circuit (FPC) cable can then be used to connect to the surface-mounted LED and EC chips with an anisotropic conductive film (ACF) to an external controller that supplies power and provides post-signal processing. Further, an adhesive (e.g., an OCA, EVA, silicone, etc.) can be used to encapsulate the LEDs and ECs (i.e., the electronic devices 50) and laminate the backer substrate 16 to the flexible glass substrate 12. An advantage of the heartbeat sensor depicted in FIG. 7A is that its backer substrate 16 with a glass composition afford the device a see-through, optical functionality. On the other hand, an advantage of the heartbeat sensor depicted in FIG. 7B is that its backer substrate 16, as made of a steel alloy, affords it added mechanical strength and toughness, particularly through the development of a favorable residual compressive stress state in the flexible glass substrate 12 upon lamination. In addition, the approaches used to configure and make the heartbeat sensors depicted in FIGS. 7A and 7B can likewise be employed to configure and make the touch sensors depicted in FIGS. 7C and 7D.

A first aspect of the disclosure pertains to a functional laminated glass article. The articles comprises: a backer substrate; a flexible glass substrate comprising a thickness of no greater than 300 μm, wherein the glass substrate is laminated to the backer substrate with an adhesive; a plurality of conductive traces disposed on one or both of the backer substrate and the flexible glass substrate; and a plurality of electronic device elements disposed between the backer substrate and the flexible glass substrate and in contact with the plurality of conductive traces. Further, the adhesive encapsulates the plurality of conductive traces and the plurality of electronic device elements between the backer substrate and the flexible glass substrate.

According to a second aspect, the first aspect is provided, wherein the backer substrate comprises a metal alloy, a polycarbonate, a glass, a ceramic, a glass-ceramic, a high pressure laminate (HPL), a medium density fiberboard (MDF), or combinations thereof.

According to a third aspect, the first or second aspect is provided, wherein the thickness of the flexible glass substrate is from 50 μm to 250 μm.

According to a fourth aspect, any one of the first through third aspects is provided, wherein the thickness of the backer substrate is from about 0.5 mm to about 50 mm.

According to a fifth aspect, any one of the first through fourth aspects is provided, wherein the adhesive comprises an optically clear adhesive (OCA), an ethylene vinyl acetate adhesive (EVA), a silicone adhesive, or an ultraviolet-curable resin adhesive.

According to a sixth aspect, any one of the first through fifth aspects is provided, wherein the plurality of conductive traces comprises an electrical resistivity from 0.1 Ω·cm to 1 Ω·cm.

According to a seventh aspect, any one of the first through sixth aspects is provided, wherein the article functions as one or more of a heartbeat sensor, a touch sensor, a light-emitting diode (LED) display, an organic light-emitting diode (OLED) display, OLED lighting, a radio frequency identification (RFID) antenna or other antenna, a motion sensor, a photovoltaic device, and an electromagnetic shielding and filtering device.

An eighth aspect of the disclosure pertains to a method of making a functional laminated glass article. The method comprises: forming a plurality of conductive traces on one or both of a backer substrate and a flexible glass substrate; mounting a plurality of electronic device elements in contact with the plurality of conductive traces and between the backer substrate and the flexible glass substrate;
encapsulating the plurality of conductive traces and the plurality of electronic device elements with an adhesive; and laminating the backer substrate and the flexible glass substrate with the adhesive. Further, the flexible glass substrate has a thickness of no greater than 300 μm.

According to a ninth aspect, the eighth aspect is provided, wherein the step of forming the plurality of conductive traces is conducted by one or more of a gravure offset printing (GOP) process, an electroless deposition (ELD) process, a laser-assisted selective deposition process, and a laser jet printing process.

According to a tenth aspect, the eighth or ninth aspect is provided, wherein the plurality of conductive traces comprises an electrical resistivity from 0.1 Ω·cm to 1 Ω·cm.

According to an eleventh aspect, any one of the eighth through tenth aspects is provided, wherein the step of mounting the plurality of electronic device elements is conducted with a surface mounting process such that each electronic device element is in electrical contact with one or more of the traces with a conductive epoxy paste.

According to a twelfth aspect, any one of the eighth through eleventh aspects is provided, wherein the step of encapsulating the plurality of conductive traces and the plurality of electronic device elements is conducted by one of a nip-roller process, a stamping process and a dam-to-fill process, and wherein the adhesive comprises an optically clear adhesive (OCA), an ethylene vinyl acetate adhesive (EVA), a silicone adhesive, or an ultraviolet-curable resin adhesive.

According to a thirteenth aspect, any one of the eighth through twelfth aspects is provided, wherein the thickness of the flexible glass substrate is from 50 μm to 250 μm, and wherein the thickness of the backer substrate is from about 0.5 mm to about 50 mm.

According to a fourteenth aspect, any one of the eighth through thirteenth aspects is provided, wherein the backer substrate comprises a metal alloy, a polycarbonate, a glass, a ceramic, a glass-ceramic, a high pressure laminate (HPL), a medium density fiberboard (MDF), or combinations thereof.

A fifteenth aspect of the disclosure pertains to a method of making a functional laminated glass article. The method comprises: forming a plurality of electronic devices in situ on one or both of a backer substrate and a flexible glass substrate; encapsulating the plurality of electronic devices with an adhesive; and
laminating the backer substrate and the flexible glass substrate with the adhesive. Further, the flexible glass substrate has a thickness of no greater than 300 μm.

According to a sixteenth aspect, the fifteenth aspect is provided, wherein the step of forming the plurality of electronic devices in situ comprises one or more of a gravure offset printing (GOP) process, an electroless deposition (ELD) process, a surface mounting process, a laser-assisted selective deposition process, and a laser jet printing process.

According to a seventeenth aspect, the fifteenth or sixteenth aspect is provided, wherein the step of encapsulating the plurality of electronic devices is conducted by one of a nip-roller process, a stamping process and a dam-to-fill process, and wherein the adhesive comprises an optically clear adhesive (OCA), an ethylene vinyl acetate adhesive (EVA), or a silicone adhesive.

According to an eighteenth aspect, any one of the fifteenth through seventeenth aspects is provided, wherein the thickness of the flexible glass substrate is from 50 μm to 250 μm.

According to a nineteenth aspect, any one of the fifteenth through eighteenth aspects is provided, wherein the thickness of the backer substrate is from about 0.5 mm to about 50 mm.

According to a twentieth aspect, any one of the fifteenth through nineteenth aspects is provided, wherein the backer substrate comprises a metal alloy, a polycarbonate, a glass, a ceramic, a glass-ceramic, a high pressure laminate (HPL), a medium density fiberboard (MDF), or combinations thereof.

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. More generally, all such modifications and variations are intended to be included herein within the scope of this disclosure and protected by the following claims.

1. A functional laminated glass article, comprising:
a backer substrate;
a flexible glass substrate comprising a thickness of no greater than 300 μm, wherein the glass substrate is laminated to the backer substrate with an adhesive;
a plurality of conductive traces disposed on one or both of the backer substrate and the flexible glass substrate; and
a plurality of electronic device elements disposed between the backer substrate and the flexible glass substrate and in contact with the plurality of conductive traces,
wherein the adhesive encapsulates the plurality of conductive traces and the plurality of electronic device elements between the backer substrate and the flexible glass substrate.

2. The glass article according to claim 1, wherein the backer substrate comprises a metal alloy, a polycarbonate, a glass, a ceramic, a glass-ceramic, a high pressure laminate (HPL), a medium density fiberboard (MDF), or combinations thereof.

3. The glass article according to claim 1, wherein the thickness of the flexible glass substrate is from 50 μm to 250 μm.

4. The glass article according to claim 1, wherein the thickness of the backer substrate is from about 0.5 mm to about 50 mm.

5. The glass article according to claim 1, wherein the adhesive comprises an optically clear adhesive (OCA), an ethylene vinyl acetate adhesive (EVA), a silicone adhesive, or a ultraviolet-curable resin adhesive.

6. The glass article according to claim 1, wherein the plurality of conductive traces comprises an electrical resistivity from 0.1 Ω·cm to 1 Ω·cm.

7. The glass article according to claim 1, wherein the article functions as one or more of a heartbeat sensor, a touch sensor, a light-emitting diode (LED) display, an organic light-emitting diode (OLED) display, OLED lighting, a radio frequency identification (RFID) antenna or other antenna, a motion sensor, a photovoltaic device, and an electromagnetic shielding and filtering device.

8. A method of making a functional laminated glass article, comprising:
forming a plurality of conductive traces on one or both of a backer substrate and a flexible glass substrate;
mounting a plurality of electronic device elements in contact with the plurality of conductive traces and between the backer substrate and the flexible glass substrate;
encapsulating the plurality of conductive traces and the plurality of electronic device elements with an adhesive; and
laminating the backer substrate and the flexible glass substrate with the adhesive,
wherein the flexible glass substrate has a thickness of no greater than 300 μm.

9. The method according to claim 8, wherein the step of forming the plurality of conductive traces is conducted by one or more of a gravure offset printing (GOP) process, an electroless deposition (ELD) process, a laser-assisted selective deposition process, and a laser jet printing process.

10. The method according to claim 8, wherein the plurality of conductive traces comprises an electrical resistivity from 0.1 Ω·cm to 1 Ω·cm.

11. The method according to claim 8, wherein the step of mounting the plurality of electronic device elements is conducted with a surface mounting process such that each electronic device element is in electrical contact with one or more of the traces with a conductive epoxy paste.

12. The method according to claim 8, wherein the step of encapsulating the plurality of conductive traces and the plurality of electronic device elements is conducted by one of a nip-roller process, a stamping process and a dam-to-fill process, and wherein the adhesive comprises an optically clear adhesive (OCA), an ethylene vinyl acetate adhesive (EVA), a silicone adhesive, or ultraviolet-curable resin adhesive.

13. The method according to claim 8, wherein the thickness of the flexible glass substrate is from 50 μm to 250 μm, and wherein the thickness of the backer substrate is from about 0.5 mm to about 50 mm.

14. The method according to claim 8, wherein the backer substrate comprises a metal alloy, a polycarbonate, a glass, a ceramic, a glass-ceramic, a high pressure laminate (HPL), a medium density fiberboard (MDF), or combinations thereof.

15. A method of making a functional laminated glass article, comprising:
forming a plurality of electronic devices in situ on one or both of a backer substrate and a flexible glass substrate;
encapsulating the plurality of electronic devices with an adhesive; and
laminating the backer substrate and the flexible glass substrate with the adhesive,
wherein the flexible glass substrate has a thickness of no greater than 300 μm.

16. The method according to claim 15, wherein the step of forming the plurality of electronic devices in situ comprises one or more of a gravure offset printing (GOP) process, an electroless deposition (ELD) process, a surface mounting process, a laser-assisted selective deposition process, and a laser jet printing process.

17. The method according to claim 15, wherein the step of encapsulating the plurality of electronic devices is conducted by one of a nip-roller process, a stamping process and a dam-to-fill process, and wherein the adhesive comprises an optically clear adhesive (OCA), an ethylene vinyl acetate adhesive (EVA), or a silicone adhesive.

18. The method according to claim 15, wherein the thickness of the flexible glass substrate is from 50 μm to 250 μm.

19. The method according to claim 15, wherein the thickness of the backer substrate is from about 0.5 mm to about 50 mm.

20. The method according to claim 15, wherein the backer substrate comprises a metal alloy, a polycarbonate, a glass, a ceramic, a glass-ceramic, a high pressure laminate (HPL), a medium density fiberboard (MDF), or combinations thereof.
